(19) United States
(12) Patent Application Publication
(10) Pub. No.: US 2013/0161392 A1
(43) Pub. Date: Jun. 27, 2013

(54) AIMING METHOD FOR ROLLING SHUTTER IMAGE SENSORS

(71) Applicants: David P. Goren, Smithtown, NY (US); Vladimir Gurevich, Stony Brook, NY (US); Carl D. Wittenberg, Water Mill, NY (US)

(72) Inventors: David P. Goren, Smithtown, NY (US); Vladimir Gurevich, Stony Brook, NY (US); Carl D. Wittenberg, Water Mill, NY (US)

(73) Assignee: Symbol Technologies, Inc., Holtsville, NY (US)

(21) Appl. No.: 13/334,193

(22) Filed: Dec. 22, 2011

(51) Int. Cl. G06K 7/14

(52) U.S. Cl. 235/455

(57) ABSTRACT

A method includes capturing an image of a target object within a field of view through an imaging lens arrangement with an imaging sensor during a frame exposure time period in rolling shutter mode. The method further includes activating an aiming light source to generate a visible aiming light pattern towards the target object during a part of the frame exposure time period and to substantially deactivate the aiming light source during the remaining part of the frame exposure time period.

### FIELD OF THE DISCLOSURE

The present disclosure relates generally to imaging-based barcode scanners.

### BACKGROUND

Various electro-optical systems have been developed for reading optical indicia, such as barcodes. A barcode is a coded pattern of graphical indicia comprised of a series of bars and spaces of varying widths. In a barcode, the bars and spaces having differing light reflecting characteristics. Some of the barcodes have a one-dimensional structure in which bars and spaces are spaced apart in one direction to form a row of patterns. Examples of one-dimensional barcodes include Uniform Product Code (UPC), which is typically used in retail store sales. Some of the barcodes have a two-dimensional structure in which multiple rows of bar and space patterns are vertically stacked to form a single barcode. Examples of two-dimensional barcodes include Code 49 and PDF417.

Systems that use one or more solid-state imagers for reading and decoding barcodes are typically referred to as imaging-based barcode readers, imaging scanners, or imaging readers. A solid-state imager generally includes a plurality of photosensitive elements or pixels aligned in one or more arrays. Examples of solid-state imagers include charged coupled devices (CCD) or complementary metal oxide semiconductor (CMOS) imaging chips.

### SUMMARY

In one aspect, the invention is directed to a method. A method includes capturing an image of a target object within a field of view through an imaging lens arrangement with an imaging sensor during a frame exposure time period in rolling shutter mode. The imaging sensor has rows of photosensitive elements arranged in a matrix wherein each row of photosensitive elements is associated with a corresponding row exposure time period within the frame exposure time period. The method further includes activating an aiming light source to generate a visible aiming light pattern towards the target object during a part of the frame exposure time period and to substantially deactivate the aiming light source during the remaining part of the frame exposure time period.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows an imaging scanner in accordance with some embodiments.

FIG. 2 is a schematic of an imaging scanner in accordance with some embodiments.

FIGS. 3A-3B depict the aim pattern timing using a global shutter sensor as practiced in the prior art.

FIG. 4 shows an aim pattern consisting of a line and a bright central dot in accordance with some embodiments.

FIGS. 5A-5B depict the aim pattern timing using a rolling shutter in accordance with some embodiments when the aim pattern of FIG. 4 is used.

FIG. 6 shows an aim pattern that indicates the entire filed-of-view in accordance with some embodiments.

FIG. 7 depicts the aim pattern timing using a rolling shutter in accordance with some embodiments when the aim pattern of FIG. 6 is used.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

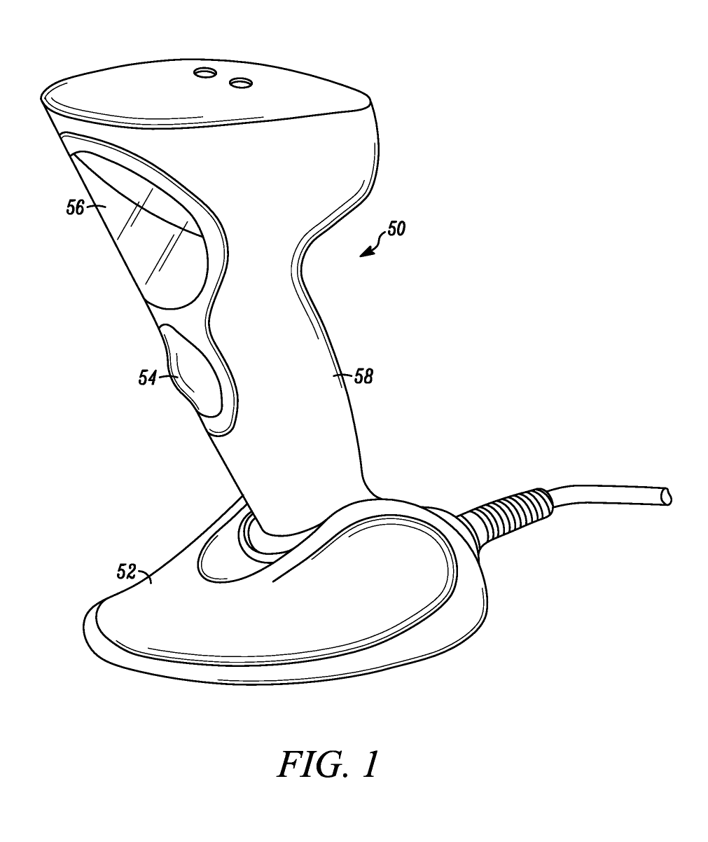

FIG. 1 shows an imaging scanner 50 in accordance with some embodiments. The imaging scanner 50 has a window 56 and a housing 58 with a handle. The imaging scanner 50 also has a base 52 for supporting itself on a countertop. The imaging scanner 50 can be used in a hands-free mode as a stationary workstation when it is placed on the countertop. The imaging scanner 50 can also be used in a handheld mode when it is picked up off the countertop and held in an operator's hand. In the hands-free mode, products can be slid, swiped past, or presented to the window 56. In the handheld mode, the imaging scanner 50 can be moved towards a barcode on a product, and a trigger 54 can be manually depressed to initiate imaging of the barcode. In some implementations, the base 52 can be omitted, and the housing 58 can also be in other shapes. In FIG. 1, a cable is also connected to the base 52. In other implementations, when the cable connected to the base 52 is omitted, the imaging scanner 50 can be powered by an on-board battery and it can communicate with a remote host by a wireless link.

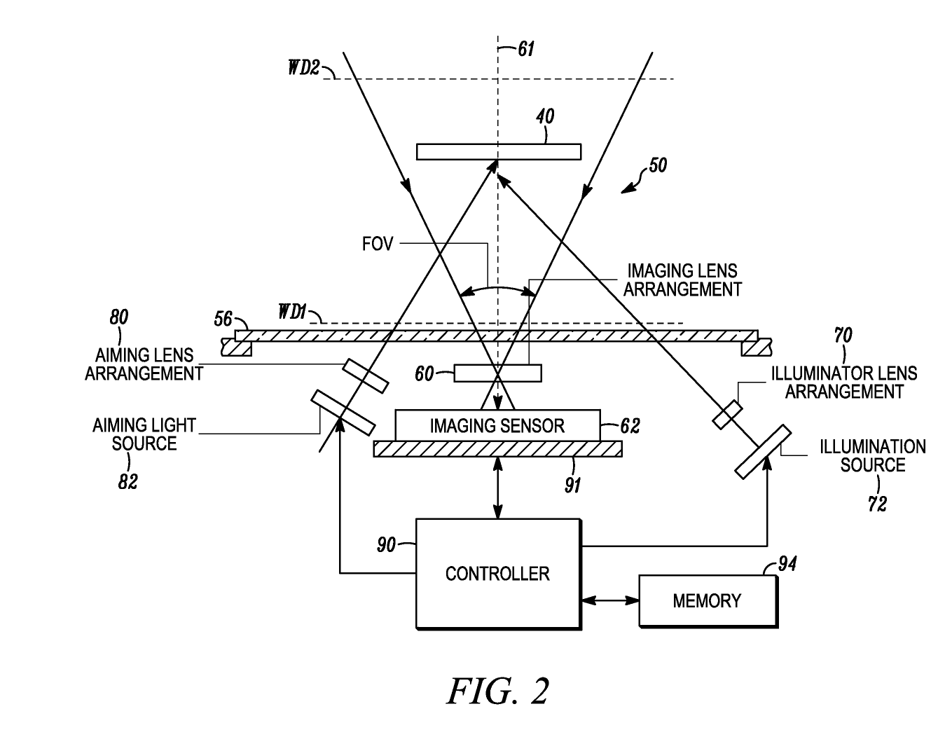

FIG. 2 is a schematic of an imaging scanner 50 in accordance with some embodiments. The imaging scanner 50 in FIG. 2 includes the following components: (1) an imaging sensor 62 positioned behind an imaging lens arrangement 60; (2) an illuminating lens arrangement 70 positioned in front of an illumination source 72; (3) an aiming lens arrangement 80 positioned in front of an aiming light source 82; and (4) a controller 90. In FIG. 2, the imaging lens arrangement 60, the illuminating lens arrangement 70, and the aiming lens arrangement 80 are positioned behind the window 56. The imaging sensor 62 is mounted on a printed circuit board 91 in the imaging scanner.

The imaging sensor 62 can be a CCD or a CMOS imaging device. The imaging sensor 62 generally includes multiple pixel elements. These multiple pixel elements can be formed by a one-dimensional array of photosensitive elements arranged linearly in a single row. These multiple pixel elements can also be formed by a two-dimensional array of photosensitive elements arranged in mutually orthogonal rows and columns. The imaging sensor 62 is operative to detect light captured by an imaging lens arrangement 60 along an optical path or axis 61 through the window 56. Generally, the imaging sensor 62 and the imaging lens arrangement 60 are designed to operate together for capturing light scattered or reflected from a barcode 40 as pixel data over a two-dimensional field of view (FOV).

The barcode 40 generally can be located anywhere in a working range of distances between a close-in working distance (WD1) and a far-out working distance (WD2). In one specific implementation, WD1 is in a close proximity to the window 56, and WD2 is about a couple of feet from the window 56. Some of the imaging scanners can include a range finding system for measuring the distance between the barcode 40 and the imaging lens arrangement 60. Some of the imaging scanners can include an auto-focus system to enable a barcode be more clearly imaged with the imaging sensor 62 based on the measured distance of this barcode. In some implementations of the auto-focus system, the focus length of the imaging lens arrangement 60 is adjusted based on the measured distance of the barcode. In some other implementations of the auto-focus system, the distance between the imaging lens arrangement 60 and the imaging sensor 62 is adjusted based on the measured distance of the barcode.

In FIG. 2, the illuminating lens arrangement 70 and the illumination source 72 are designed to operate together for generating an illuminating light towards the barcode 40 during an illumination time period. The illumination source 72 can include one or more light emitting diodes (LED). The illumination source 72 can also include a laser or other kind of light sources. The aiming lens arrangement 80 and the aiming light source 82 are designed to operate together for generating a visible aiming light pattern towards the barcode 40. Such aiming pattern can be used by the operator to accurately aim the imaging scanner at the barcode. The aiming light source 82 can include one or more light emitting diodes (LED). The aiming light source 82 can also include a laser, LED, or other kind of light sources.

In FIG. 2, the controller 90, such as a microprocessor, is operatively connected to the imaging sensor 62, the illumination source 72, and the aiming light source 82 for controlling the operation of these components. The controller 90 can also be used to control other devices in the imaging scanner. The imaging scanner 50 includes a memory 94 that can be accessible by the controller 90 for storing and retrieving data. In many embodiments, the controller 90 also includes a decoder for decoding one or more barcodes that are within the field of view (FOV) of the imaging scanner 50. In some implementations, the barcode 40 can be decoded by digitally processing a captured image of the barcode with a microprocessor.

In operation, in accordance with some embodiments, the controller 90 sends a command signal to energize the illumination source 72 for a predetermined illumination time period. The controller 90 then exposes the imaging sensor 62 to capture an image of the barcode 40. The captured image of the barcode 40 is transferred to the controller 90 as pixel data. Such pixel data is digitally processed by the decoder in the controller 90 to decode the barcode. The information obtained from decoding the barcode 40 is then stored in the memory 94 or sent to other devices for further processing.

Barcode imaging scanners typically project a bright aiming pattern (e.g., a dot, line, cross pattern, etc.) to assist the user in aiming the scanner towards the barcode. When aimed properly, the aim pattern will be projected onto the desired barcode. The aim pattern should be as bright as possible to be visible under high ambient light conditions. To make the aim pattern appear bright, we want to keep the aimer on as much as possible. However, we want the aimer off when collecting images to be processed by the barcode decode software so that the aiming pattern does not appear in the image. If the aim pattern appears in the image, it may negatively affect the decoding of the barcode. The problem becomes more challenging with the use of a rolling shutter image sensor as opposed to a global shutter sensor. Using a rolling shutter sensor saves cost and reduces size, as rolling shutter sensors are typically smaller and less expensive than global shutter sensors.

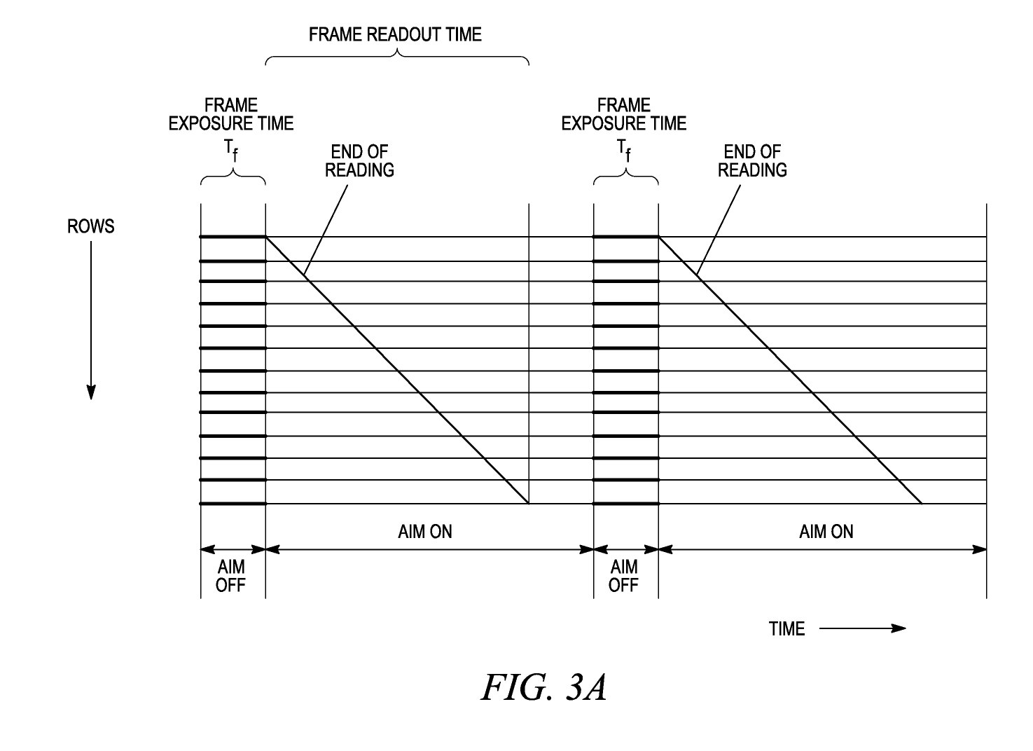

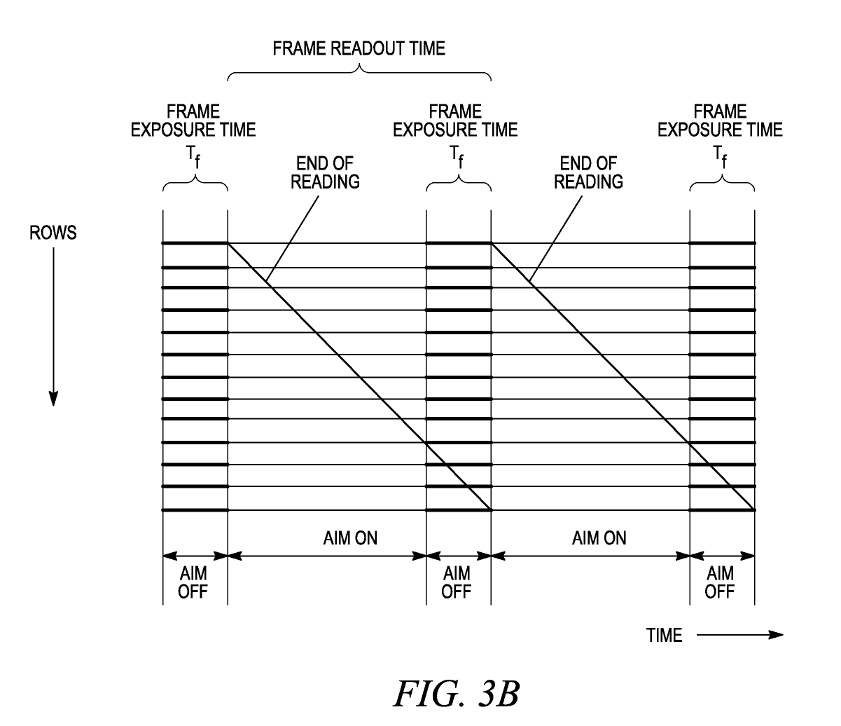

The aim pattern timing using a global shutter sensor as practiced in the prior art is shown in FIGS. 3A-3B. A global shutter sensor exposes all the pixels simultaneously during a frame exposure time T_{f} and stores each pixel value within the pixel. After the exposure is finished, the pixels are read out. In FIGS. 3A-3B, the reading on each row of pixels finishes at a time as indicated by the line identified by “end of reading.” If the frame exposure time T_{f} is less than the frame readout time, the aim pattern can be turned on during the readout time after the current exposure is completed and before the next exposure starts. In this way, the image sensor can output images at its maximum rate and not have the aim pattern appear in any of the images. In a barcode scanner, the frame exposure times are typically substantially less than the frame readout time resulting in the aimer being on >50% of the time. Due to the global shutter, there is no limitation to the aiming pattern's size and shape as there are no pixels being exposed during the aim on time.

To reduce the size and cost of a barcode imager, a rolling shutter sensor can be used instead of a global shutter sensor. Unlike a global shutter sensor that has storage in each pixel, a rolling shutter sensor does not have storage in each pixel. In order for each row to be exposed the same amount of time, each row is exposed and read out in a staggered sequence until the entire frame is completed. Because different rows are being exposed at different times during the frame, one cannot prevent an arbitrary aim pattern form appearing in the image (e.g., a cross pattern with a vertical component that spans all the rows).

One solution is to turn on the aimer every other frame. This would result in a duty cycle of 50%, but the aim pattern may appear in every other image affecting the decode rate. This patent specification describes a method of combining an aiming pattern with particular properties with the appropriate timing to overcome this limitation and produce a bright aiming pattern without the pattern appearing in any of the images.

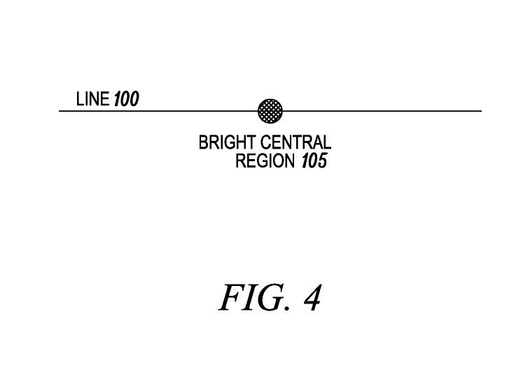

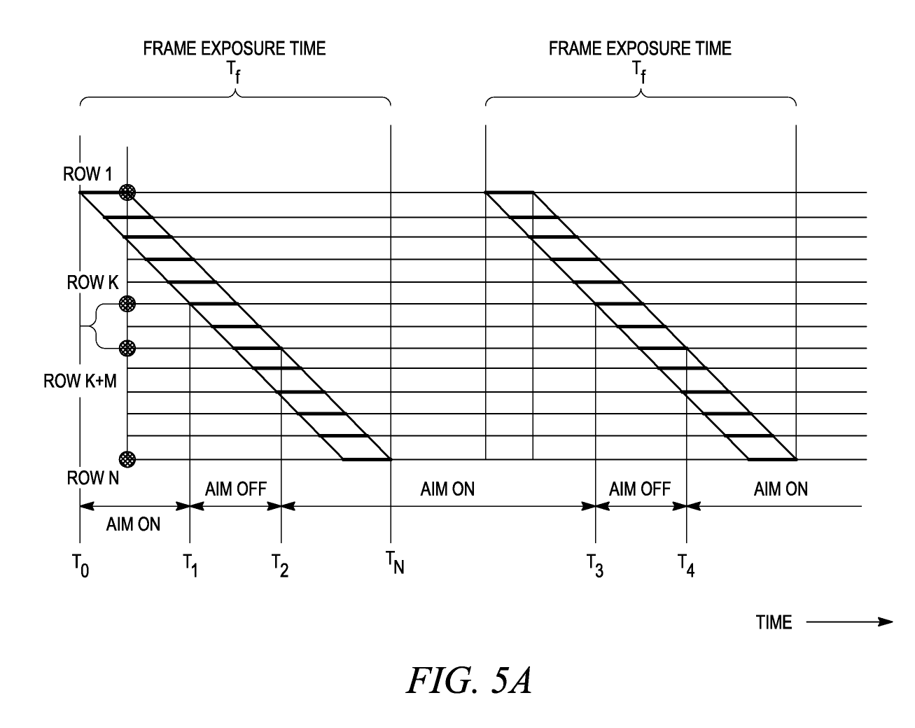

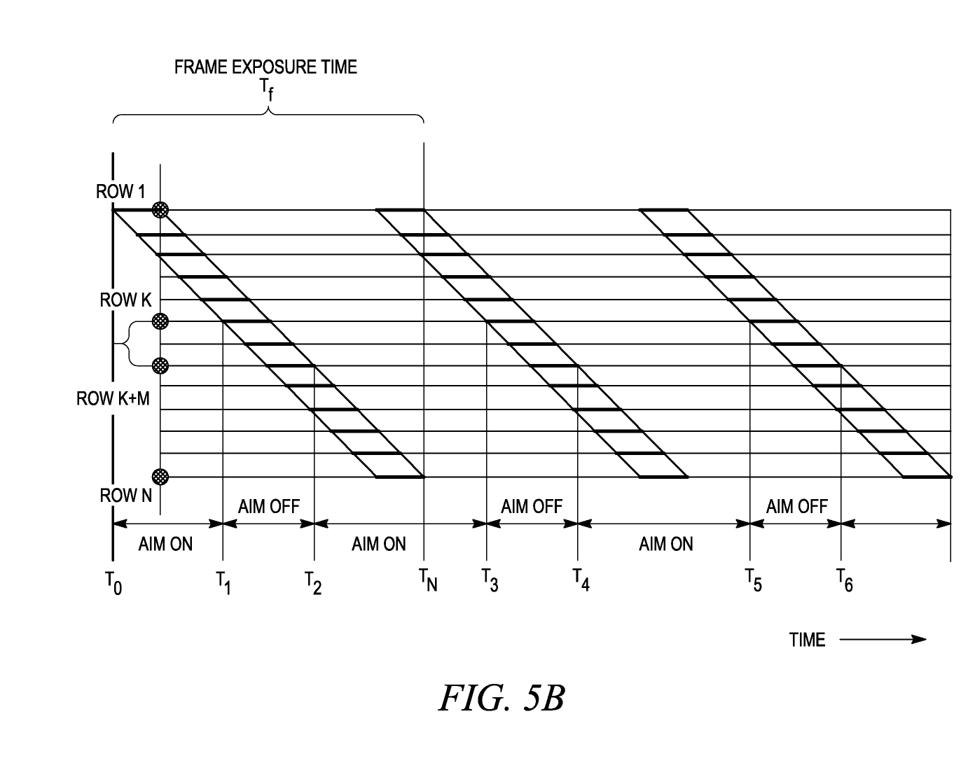

Consider an aim pattern consisting of a line 100 and a bright central dot 105 as show in FIG. 4. Such a pattern can be generated with a laser using a combination of diffractive and refractive elements. One property of this aiming pattern is that it is mainly horizontal and has no substantial vertical component. When projected onto a barcode, this aim pattern will only appear in a finite number of rows. The aim pattern timing using a rolling shutter with this aim pattern is shown in FIGS. 5A-5B. In rolling shutter mode, each given row of photosensitive elements is associated with a corresponding row exposure time period during which the amount of light impinging upon on each photosensitive element in the given row is converted into electrical signal. In rolling shutter mode, the frame exposure time T_{f} covers the row exposure time periods for all rows in the imaging sensor. For example, in FIGS. 5A-5B, the frame exposure time T_{f} starts from the beginning T₀ of the row exposure time period for first row (i.e., Row 1) and finishes at the ending T_{N} of the row exposure time period for last row (i.e., Row N)

The visible aiming light pattern in FIG. 4 is designed with a predetermined pattern and aligned with the field of view of the image sensor to have only a fraction of the rows of photosensitive elements receiving substantial amount of returned light due to the visible aiming light pattern. For example, in FIGS. 5A-5B, the visible aiming light pattern—if turned on continuously—would appear only in rows K through K+M in the image. As shown in FIGS. 5A-5B, rows K through K+M are only exposed between times T₁ and T₂, which covers substantially all of the corresponding row exposure time period for each row from row K to row K+M. In FIGS. 5A-5B, time T₁ is the beginning of the row exposure time period for row K, and time T₂ is the ending of the row exposure time period for row K+M. If the aim pattern is turned off between time T₁ and time T₂, the aim pattern will not appear in the image. The aim pattern can be turned on for any duration within the time period between T₀ and T₁ or between the timer periods between T₂ to T_{N}. In some embodiments, the aim pattern is turned on from time T₂ in the current frame to time T₃ in the next frame, where time T₃ is the beginning of the row exposure time period for row K in the next frame. For the aiming pattern as shown in FIG. 4, it is rather simple to make the aiming-on time period (T₃−T₂) larger than the aiming-off time period (T₂−T₁) in order to achieve a duty cycle larger than 50% for the aiming pattern.

When visible aiming light pattern in FIG. 4 is designed with a predetermined pattern and aligned with the field of view of the image sensor, it is helpful to have the parallax of the aiming pattern appear in the horizontal direction. This will maximize the amount of rows the aim pattern can be on and thereby increase visibility. Generally, the embodiments of present invention involve using a rolling shutter sensor, choosing an appropriate aim pattern, and timing the aim pattern to prevent the aimer from appearing in any images while achieving maximum frame rate for decoding.

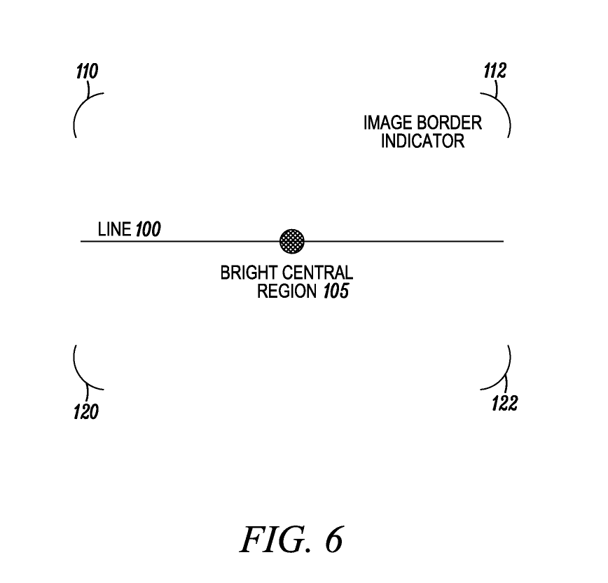

Other aim patterns are also possible. If the imager will also be used for document capture, an aim pattern that indicates the entire filed-of-view is useful. One example of such an aim pattern is shown in FIG. 6. In some embodiments, the line/central dot pattern in the image as shown in FIG. 6 can be removed. The image border patterns can either be made just outside the field-of-view of the imager, or left in the image taking up a small area of the image.

The techniques described above can be generalized to any aim pattern that can be split into a number or row regions. The timing of the aim pattern can be generalized to turn off the aiming pattern for each row region. For example, the aiming pattern, as shown in FIG. 6, can be split into three regions, a top region consisting of the upper border indicators 110 and 112, the middle region consisting of the line 100 and dot 105, and the bottom region consisting of the lower border indicators 120 and 122.

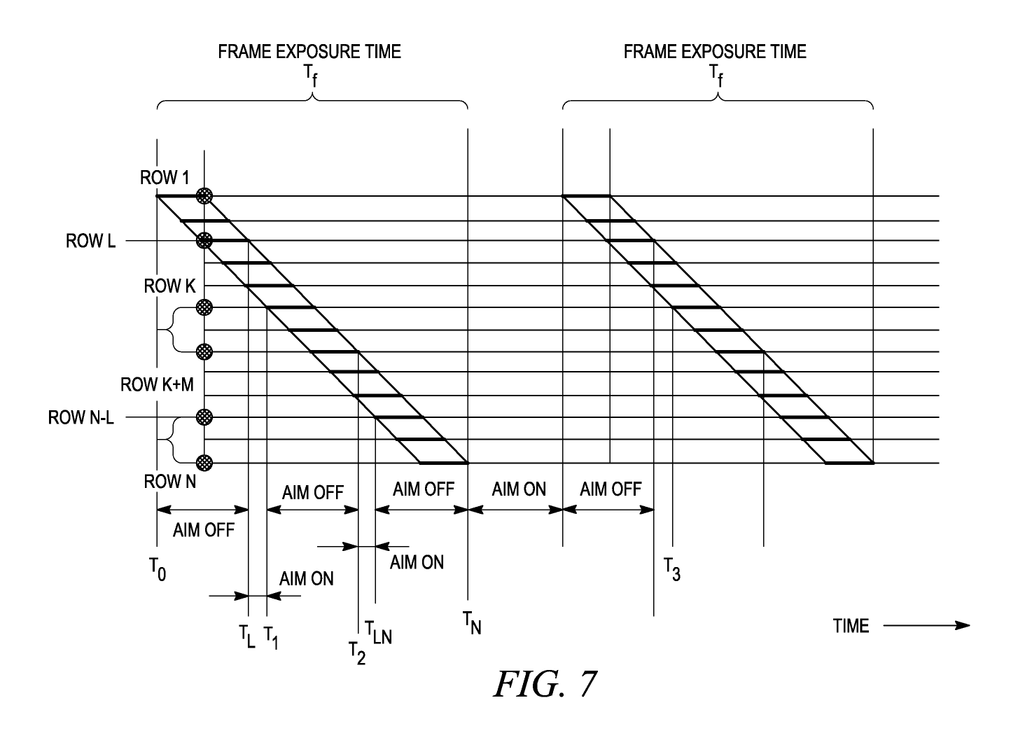

When visible aiming light pattern in FIG. 6 is aligned with the field of view of the image sensor, only a fraction of the rows of photosensitive elements receiving substantial amount of returned light due to the visible aiming light pattern. For example, as shown in FIG. 7, the visible aiming light pattern—if turned on continuously—would appear only in three groups of rows in the image: (1) rows 1 through L, (2) rows K through K+M, and (3) rows N−L through N. In FIG. 7, time T₀ and time T_{LN} is respectively the beginning of the row exposure time period for row 1 and row N−L; time T_{L} and time T_{N} is respectively the ending of the row exposure time period for row L and row N. If the visible aiming light pattern in FIG. 6 is turned on continuously, the three groups of rows in FIG. 7 would be exposed during three time periods: (1) the time period between time T₀ and time T_{L}, (2) the time period between time T₁ and time T₂, and (3) the time period between time T_{N-L} and time T_{N}. If the aim pattern is turned off during these three time periods, the aim pattern of FIG. 6 will not appear in the image of FIG. 7. The aim pattern can be turned on for any duration outside the above specified three time periods.

The techniques described can be generalized to include using aiming patterns that consist of multiple aiming regions that can be controlled separately. Each separate aiming pattern can be individually controlled and timed to achieve maximum brightness (i.e., on time) and not appear in the image. For example, as shown in FIG. 7, if the upper border indicators 110 and 112 in FIG. 6 are turned off during the time period between time T₀ and time T_{L} and they are tuned back on during any time outside the time period between time T₀ and time T_{L}, the upper border indicators 110 and 112 will not appear in the image. Similarly, as shown in FIG. 7, if the line/dot 100 and 105 in FIG. 6 are turned off during the time period between time T₁ and time T₂ and they are tuned back on during any time outside the time period between time T₁ and time T₂, the line/dot 100 and 105 will not appear in the image. Also similarly, as shown in FIG. 7, if the lower border indicators 120 and 122 in FIG. 6 are turned off during the time period between time T_{N-L} and time T_{N} and they are tuned back on during any time outside the time period between time T_{N-L} and time T_{N}, the lower border indicators 120 and 122 will not appear in the image.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
an imaging sensor having rows of photosensitive elements arranged in a matrix, the imaging sensor being configured to capture an image from a target object during a frame exposure time period in rolling shutter mode wherein each row of photosensitive elements is associated with a corresponding row exposure time period;
an imaging lens arrangement configured to operate together with the imaging sensor for detecting light from the target object within a field of view;
an illumination source for providing illumination directed toward the target object;
an aiming light source for generating a visible aiming light pattern towards the target object; and
a controller operative to activate the aiming light source during a part of the frame exposure time period and to substantially deactivate the aiming light source during the remaining part of the frame exposure time period.

2. The apparatus of claim 1, wherein the visible aiming light pattern is designed with a predetermined pattern and aligned with the field of view to have majority of the rows of photosensitive elements in the imaging sensor receiving substantially no returned light due to the visible aiming light pattern.

3. The apparatus of claim 2, wherein the predetermined pattern includes a horizontal line.

4. The apparatus of claim 2, wherein the predetermined pattern includes a horizontal line and a spot on the horizontal line

5. The apparatus of claim 2, wherein the predetermined pattern includes a plurality of boarder indicators.

6. The apparatus of claim 1, wherein the visible aiming light pattern is designed with a predetermined pattern and aligned with the field of view to have only a fraction of the rows of photosensitive elements receiving substantial amount of returned light due to the visible aiming light pattern during the part of the frame exposure time period when the aiming light source is activated, and wherein the remaining part of the frame exposure time period during which the aiming light source is substantially deactivated covers substantially all of the corresponding row exposure time period for each row belong to said fraction of the rows of photosensitive elements.

7. The apparatus of claim 6, wherein said fraction of the rows of photosensitive elements is less than 50% of the total number of the rows in the imaging sensor

8. The apparatus of claim 6, wherein said fraction of the rows of photosensitive elements is less than 20% of the total number of the rows in the imaging sensor

9. The apparatus of claim 6, wherein said fraction of the rows of photosensitive elements is less than 10% of the total number of the rows in the imaging sensor

10. The apparatus of claim 1, wherein the visible aiming light pattern is designed with a predetermined pattern and aligned with the field of view to have at least 80% of the rows of photosensitive elements in the imaging sensor receiving substantially no returned light due to the visible aiming light pattern, and wherein the part of the frame exposure time period during which the aiming light source is activated covers majority of the corresponding row exposure time period for each of the at least 80% of the rows of photosensitive elements receiving substantially no returned light due to the visible aiming light pattern.

11. The apparatus of claim 1, wherein the visible aiming light pattern is designed with a predetermined pattern and aligned with the field of view to have at least 90% of the rows of photosensitive elements in the imaging sensor receiving substantially no returned light due to the visible aiming light pattern, and wherein the part of the frame exposure time period during which the aiming light source is activated covers majority of the corresponding row exposure time period for each of the at least 90% of the rows of photosensitive elements receiving substantially no returned light due to the visible aiming light pattern.

12. A method comprising:
capturing an image of a target object within a field of view through an imaging lens arrangement with an imaging sensor during a frame exposure time period in rolling shutter mode, the imaging sensor having rows of photosensitive elements arranged in a matrix wherein each row of photosensitive elements is associated with a corresponding row exposure time period within the frame exposure time period; and
activating an aiming light source to generate a visible aiming light pattern towards the target object during a part of the frame exposure time period and to substantially deactivate the aiming light source during the remaining part of the frame exposure time period.

13. The method of claim 12, wherein the visible aiming light pattern is designed with a predetermined pattern and aligned with the field of view to have only a fraction of the rows of photosensitive elements receiving substantial amount of returned light due to the visible aiming light pattern during the part of the frame exposure time period when the aiming light source is activated, and wherein the remaining part of the frame exposure time period during which the aiming light source is substantially deactivated covers substantially all of the corresponding row exposure time period for each row belong to said fraction of the rows of photosensitive elements.

14. The method of claim 13, wherein said fraction of the rows of photosensitive elements is less than 50% of the total number of the rows in the imaging sensor.

15. The method of claim 13, wherein said fraction of the rows of photosensitive elements is less than 20% of the total number of the rows in the imaging sensor.

16. The method of claim 13, wherein said fraction of the rows of photosensitive elements is less than 10% of the total number of the rows in the imaging sensor.

17. An apparatus comprising:
an imaging sensor having rows of photosensitive elements arranged in a matrix, the imaging sensor being configured to capture an image from a target object during a frame exposure time period in rolling shutter mode wherein each row of photosensitive elements is associated with a corresponding row exposure time period;
an imaging lens arrangement configured to operate together with the imaging sensor for detecting light from the target object within a field of view; and
means for activating an aiming light source to generate a visible aiming light pattern towards the target object during a part of the frame exposure time period and to substantially deactivate the aiming light source during the remaining part of the frame exposure time period.

18. The apparatus of claim 17, wherein the visible aiming light pattern is designed with a predetermined pattern and aligned with the field of view to have only a fraction of the rows of photosensitive elements receiving substantial amount of returned light due to the visible aiming light pattern during the part of the frame exposure time period when the aiming light source is activated, and wherein the remaining part of the frame exposure time period during which the aiming light source is substantially deactivated covers substantially all of the corresponding row exposure time period for each row belong to said fraction of the rows of photosensitive elements.

19. The apparatus of claim 18, wherein said fraction of the rows of photosensitive elements is less than 20% of the total number of the rows in the imaging sensor

20. The apparatus of claim 18, wherein said fraction of the rows of photosensitive elements is less than 10% of the total number of the rows in the imaging sensor
